(19) United States
(12) Patent Application Publication
(10) Pub. No.: US 2026/0222927 A1
(43) Pub. Date: Jul. 30, 2026

(54) METHOD AND APPARATUS FOR PERFORMING INTER-SYSTEM HANDOVER IN WIRELESS COMMUNICATION SYSTEM

(71) Applicant: Samsung Electronics Co., Ltd., Gyeonggi-do (KR)

(72) Inventors: Sangho LEE, Gyeonggi-do (KR); Jinho CHOI, Gyeonggi-do (KR)

(21) Appl. No.: 19/145,335

(22) PCT Filed: Jan. 6, 2023
(86) PCT No.: PCT/KR2023/000330

§ 371 Date: Jul. 2, 2025

(51) Int. Cl. H04W 36/00; H04W 64/00; H04W 74/0836

(52) U.S. Cl. CPC H04W 36/0072; H04W 64/00; H04W 74/0836

(57) ABSTRACT

The present disclosure relates to a method and an apparatus enabling delay time in an inter-system handover procedure to be reduced. A method performed by means of a first network entity for managing mobility in a first system in an inter-system handover procedure, according to an embodiment of the present disclosure, comprises the steps of: selecting, with respect to a specific service for a terminal, a target cell from among one or more candidate cells for inter-system handover from the first system to a second system; transmitting, to a second network entity for managing mobility in the second system, a first request message including type information about a random access procedure to be performed by the target cell; receiving, in response to the transmission of the first request message, a first response message including configuration information related to the inter-system handover from the second network entity; and transmitting a handover command together with the configuration information related to the inter-system handover to a base station of the first system accessed by the terminal.

### TECHNICAL FIELD

The disclosure relates to a method and apparatus for performing an inter-system handover in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

The disclosure provides an effective method and device for performing an inter-system handover in a wireless communication system.

In addition, the disclosure provides a method and device for reducing a delay time in an inter-system handover procedure.

In addition, the disclosure provides a method and device for effectively selecting a target cell in an inter-system handover.

In addition, the disclosure provides a method and apparatus for selecting an RACH type for a target cell in consideration of a delay time in an inter-system handover procedure.

### Technical Solution

According to an embodiment of the disclosure, a method performed by a first network entity that manages mobility in a first system in an inter-system handover procedure may include an operation of selecting a target cell from among at least one candidate cell for an inter-system handover from a first system to a second system, for a specific service for a user equipment (UE), an operation of transmitting, to a second network entity that manages mobility in the second system, a first request message including type information of a random-access procedure to be performed by the target cell, an operation of receiving a first response message including inter-system handover related configuration information from the second network entity in response to the transmission of the first request message, and an operation of transmitting, to a base station of the first system that the UE accesses, the inter-system handover related configuration information together with a handover command.

According to an embodiment of the disclosure, a first network entity that manages mobility in a first system may include a communication interface, and a processor, in an inter-system handover procedure, configured to select a target cell from among at least one candidate cell in order to perform an inter-system handover from the first system to a second system, for a specific service for a UE, to transmit, via the communication interface, a first request message including type information for a random access procedure to be performed in the target cell to a second network entity that manages mobility in the second system, to receive a first response message including inter-system handover related configuration information from the second network entity via the communication interface in response to the transmission of the first request message, and to transmit, to a base station of the first system that the UE accesses, the inter-system handover related configuration information together with a handover command via the communication interface.

According to an embodiment of the disclosure, a method performed by a UE in an inter-system handover procedure may include an operation of transmitting a service request message including a service type of a specific service to a first network entity that manages mobility of the UE in a first system, an operation of receiving inter-system handover related configuration information from the first network entity in response to the transmission of the service request message, and an operation of performing, based on the inter-system handover related configuration information, a random access procedure with a target cell in a second system for inter-system handover.

According to an embodiment of the disclosure, a UE in a wireless communication system may include a transceiver and a processor configured to transmit, via the transceiver, a service request message including a service type of a specific service to a first network entity that manages mobility of the UE in a first system, to receive, via the transceiver, inter-system handover related configuration information from the first network entity in response to the transmission of the service request message, and to perform, via the transceiver, a random access procedure with a target cell in a second system for inter-system handover, based on the inter-system handover related configuration information.

### BRIEF DESCRIPTION OF DRAWINGS

FIG. 1 is a diagram illustrating a network structure of a wireless communication system according to an embodiment of the disclosure;

FIGS. 2A, 2B, and 2C are diagrams briefly illustrating examples of a dual-connectivity (DC) scheme or an inter-system interworking structure applicable to a 5G system and/or 6G system according to an embodiment of the disclosure;

FIG. 3 is a diagram illustrating an example of an inter-system handover procedure in a wireless communication system that supports an emergency service fallback according to an embodiment of the disclosure;

FIGS. 4A and 4B are diagrams illustrating examples of a target cell selection operation according to an embodiment of the disclosure;

FIG. 5 is a diagram illustrating a general 2-step RACH procedure;

FIG. 6 is a diagram illustrating a scalability technology in base station virtualization;

FIG. 7 is a diagram illustrating a delay time identification procedure applied to an inter-system handover procedure according to an embodiment of the disclosure;

FIG. 8 is a diagram illustrating an example of an inter-system handover procedure in a wireless communication system that supports an emergency service fallback according to an embodiment of the disclosure;

FIG. 9 is a diagram illustrating operations performed in a first network entity of a 6G system in an inter-system handover procedure according to an embodiment of the disclosure; and

FIG. 10 is a diagram illustrating an example of a configuration of a network entity in a wireless communication system according to an embodiment of the disclosure.

### MODE FOR CARRYING OUT THE INVENTION

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help understanding of the disclosure and the disclosure is not limited to configurations or arrangements illustrated in the drawings of the disclosure. In addition, a detailed description of known functions or configurations that may make the subject matter of the disclosure unclear will be omitted. It should be noted that, in the following description, only parts required to understand operations according to various embodiments will be described and a description of the other parts will be omitted so as not to make the subject matter of the disclosure obscure. Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the following description of the disclosure, terms and names defined in the NR standards specified by the 3rd generation partnership (3GPP) group will be used for the sake of descriptive convenience. However, the terms and names as used herein will be described in connection with a 5G system by way of example, but the disclosure is not limited to the 5G system and may also be applied to a 6G system beyond the 5G system.

In the 5G system, network slicing technology is the technology and structure that enable various virtualized and independent logical networks in a single physical network. To satisfy specified requirements of a service/application, a network operator may configure a virtual end-to-end network called a network slice, and may provide a service in the 5G system. The network slice is identified by an identifier called single-network slice selection assistance information (S-NSSAI), and the network operator may provide a network slice(s) to a user equipment (UE), so as to provide a communication service.

Specifically, when registering with a network, a UE in the 5G system transmits identification information (i.e., requested S-NSSAIs) associated with network slices that the UE is to request, to an access and mobility management function (AMF), and the AMF may provide, to the UE, information (allowed NSSAI) associated with network slices that the UE is capable of using, in consideration of the requested S-NSSAIs, subscriber information, and the like. Although the UE does not provide information associated with the requested slice(s), the AMF may provide allowed NSSAI to the UE. In this instance, the allowed NSSAI may include information (default configured NSSAI) associated with a default configuration slice(s) and information (i.e., default subscribed S-NSSAI(s)) associated with a slice(s) configured as a default among subscribed network slices included in UE subscription information.

In order to perform data transmission or reception to a predetermined data network (DN) via the allowed network slice(s) (allowed NSSAI(s)), the UE may select one of the allowed network slices, may request the selected network slice to establish a packet data unit (PDU) session to a predetermined data network name (DNN), and may perform data transmission or reception via the established PDU session.

In addition, a base station in the disclosure is a subject that performs resource allocation to a user equipment (UE), and may be at least one of a gNode B, a gNB, an eNode B, an eNB, a Node B, a BS, a radio access network (RAN), a base station controller, or a node on network. The base station may be at least one network entity from among an integrated access and backhaul-doner (LAB-doner) and an IAB-node, wherein the IAB-doner is a gNB that provides, to a UE(s), network access via a network of backhaul and access links in the NR system (hereinafter, 5G system), and the IAB-node is an RAN node that supports an NR access link(s) to a UE(s) and supports a backhaul link(s) to the IAB-donor or another IAB-node. In the disclosure, a UE may be one of various wireless communication devices as well as, a portable phone, a mobile station (MS), a cellular phone, a smartphone, a computer, NB-IoT devices, or sensors.

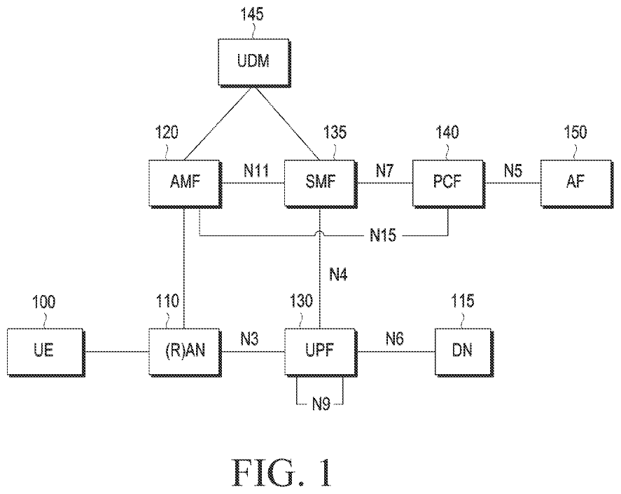

In the disclosure, for the network technology, reference has been made to the standards (e.g., TS 23.501, TS 23.502, TS 23.503, or the like) defined by International Telecommunication Union (ITU) or 3GPP. Components included in the network structure of FIG. 1 may be physical entities, software performing individual functions, or hardware combined with the software. The reference numerals denoted by Nx, such as N1, N2, N3, . . . , and the like in drawings are the publicly known interfaces between NFs in a 5G core network (CN).

FIG. 1 is a diagram illustrating a network structure of a wireless communication system according to an embodiment of the disclosure.

The system of FIG. 1 may include a 5G core network (5GC), a base station 110, and a user equipment (UE) 100. The 5GC may include an access and mobility management function (AMF) 120 that manages mobility of the UE 100, a session management function (SMF) 135 that manages a packet data unit (PDU) session of the UE 100, a user plane function (UPF) 130 that is connected to a data network (DN) 115 and performs data transferring, a policy control function (PCF) 140 that provides a policy control function, a user data management (UDM) 145 that provides a data management function such as subscriber data, policy control data or the like, a unified data repository (UDR) (not illustrated) that stores data of various network functions (NFs), a network slice selection function (NSSF) (not illustrated) that selects network slice instances serving the UE 100, a network slice admission control function (NSACF) (not illustrated) that monitors and controls the number of registered UEs in a network slice(s) and the number of PDU sessions, and the like. An application function (AF) 150 that provides an application service may perform communication with the 5GC.

The AMF 120 may be a network entity for managing access and mobility of the UE 100. For example, the AMF 120 may perform a network function such as registration, connection, reachability, mobility management, access verification, authentication, or mobility event generation in association with the UE 100. The SMF 135 may perform a management function associated with a PDU session of the UE 100. For example, the SMF 135 may perform a session management function, such as session establishment, modification, release, or the like, an internet protocol (IP) address allocation and management function associated with an IP of the UE 100, a network function such as user plane selection and control, or the like. The UPF 130 may perform a data processing function that transfers data transmitted by the UE 100 to the DN 115 that is an external network, or transfers data obtained from the DN 155 to the UE 100. In addition, the UPF 130 may perform a network function such as acting as an anchor between radio access technologies (RATs), providing a connection between a PDU session and the AF 150, packet routing and forwarding, packet inspection, applying a user plane policy, making a traffic usage report, buffering, or the like. The PCF 140 may manage operator policy information for providing a service in the 5G system, and the UDM 145 may perform a function such as generating authentication information for 3GPP security, managing a list of network functions (NF) that support the UE 100, managing subscription information, and the like. In 3GPP systems, conceptual links connecting NFs in the 5G system are defined as reference points. Next, reference points included in the 5G system architecture of FIG. 1 will be exemplified below. For the sake of descriptive convenience, some reference points are not shown in FIG. 1.
N1: a reference point between a UE and an AMF
N2: a reference point between an (R) AN and an AMF
N3: a reference point between an (R) AN and a UPF
N4: a reference point between an SMF and a UPF
N5: a reference point between a PCF and an AF
N6: a reference point between a UPF and a DN
N7: a reference point between an SMF and a PCF
N8: a reference point between a UDM and an AMF
N9: a reference point between two core UPFs
N10: a reference point between a UDM and an SMF
N11: a reference point between an AMF and an SMF
N12: a reference point between an AMF and an AUSF
N13: a reference point between a UDM and an authentication server function (AUSF)
N14: a reference point between two AMFs
N15: a reference point between a PCF and an AMF for a non-roaming scenario, and a reference point between a PCF and an AMF in a visited network for a roaming scenario

The network structure of FIG. 1 may be applied to the 6G system that is a system next to the 5G system, in the same or similar manner.

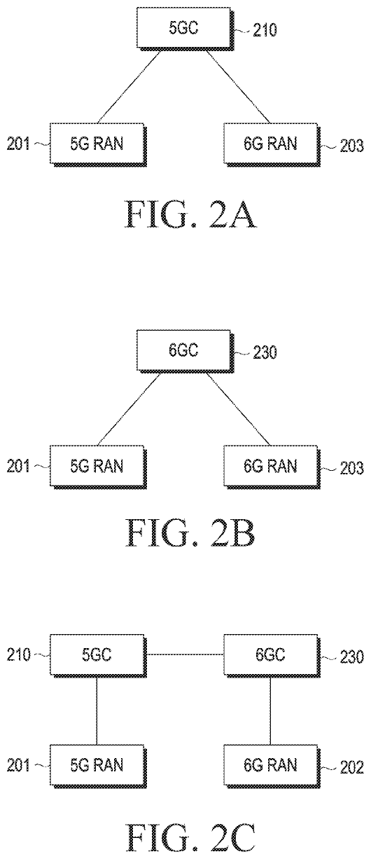

FIGS. 2A to 2C are diagrams briefly illustrating examples of a dual connectivity (DC) scheme or an inter-system interworking structure applicable to the 5G system and/or 6G system according to an embodiment of the disclosure.

Referring to TS 37.340 in the 3GPP standard, various multi-radio dual connectivity (MR-DC) structures, applicable to an evolved packet system (EPS) that is an LTE system (4G system) and an NR system that is the 5G system, are illustrated. For example, to an evolved packet core (EPC) that is a core network of an EPS, an evolved UMTS terrestrial radio access network (E-UTRAN) (i.e., 4G radio access network (RAN)) that is a base station of the LTE system and a 5G RAN that is a base station of the 5G system may be connected in a DC scheme (i.e., EN-DC). As another example, a 4G RAN and a 5G RAN may be connected to a 5GC that is a core network of the 5G system in a DC scheme (i.e., NE-DC).

FIG. 2A briefly illustrates a structure in which a 5G RAN 201 that is a base station of the 5G system and a 6G RAN 203 that is a base station of the 6G system are connected to a 5GC 210 that is a core network of the 5G system, in a DC scheme, according to an embodiment of the disclosure. FIG. 2B briefly illustrates a structure in which the 5G RAN 201 that is a base station of the 5G system and the 6G RAN 203 that is a base station of the 6G system are connected to a 6GC 230 that is a core network of the 6G system, in a DC scheme, according to an embodiment of the disclosure.

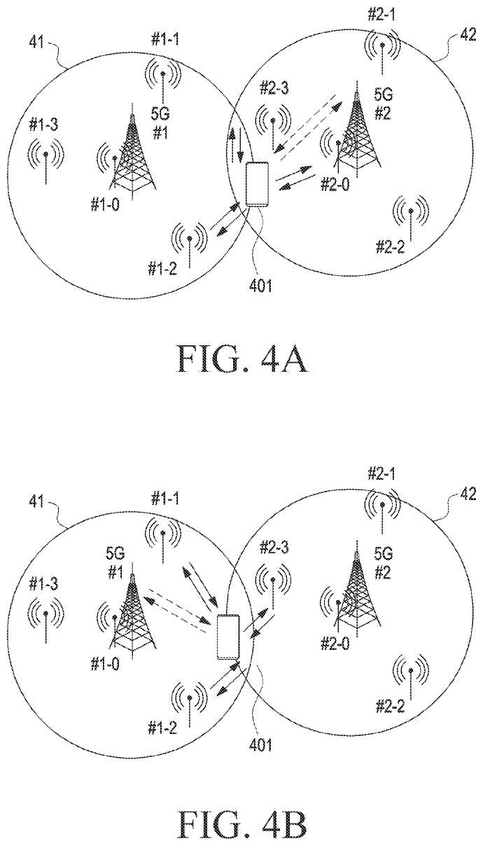

Referring to FIG. 4.2.2-2: Non-roaming architecture for interworking between 5GS and EPC/E-UTRAN in the 3GPP standard TS 23.501, a scheme of connecting and operating a 5GC-EPC in an interworking structure (or referred to as EPS-5GS interworking structure) is illustrated. In the EPS-5GS interworking structure, a UE may access the 5G system and use a service, and then may move to the EPS. Alternatively, the UE may access the EPS and use a service, and then may move to the 5G system.

FIG. 2C briefly illustrates an interworking structure in which the 5GC 210 that is a core network of the 5G system and the 6GC 230 that is a core network of the 6G system are connected in an interworking structure, and the 5G RAN 201 and the 6G RAN 203 are connected respectively to the 5GC 210 and the 6GC 230, according to an embodiment of the disclosure. In the disclosure, the interworking structure of FIG. 2C is referred to as a 5GC-6GC interworking structure. In the 5GC-6GC interworking structure, a UE may access the 6G system and use a service, and then may move to the 5G system. Alternatively, the UE may access the 5G system and use a service, and then may move to the 6G system. In the 5GC-6GC interworking structure of FIG. 2C, the 5G RAN 201 and the 6G RAN 203 are not connected to a common core network as illustrated in FIG. 2A or 2B, and thus, for example, RRC transfer using an Xn interface defined in 3GPP TS 38.423 may not be performed between the 5G RAN 201 and the 6G RAN 203. It describes that direct signaling using an Xn interface may not be performed between the 5G RAN 201 and the 6G RAN 203 in the 5GC-6GC interworking structure of FIG. 2C. In addition, although an exceptional case that is capable of using an Xn interface is assumed, intra-AMF mobility is unavailable. Therefore, when an inter-system handover procedure is performed in the 5GC-6GC interworking structure of FIG. 2C, signaling between the 5G RAN 201 and the 6G RAN 203 needs a signaling procedure that goes through the 5GC 210 and the 6GC 230.

The UE in an embodiment of the disclosure may receive a specific service via an inter-system handover that uses interworking between the 6G system and the 5G system. The specific service may be, for example, an emergency service fallback, or the like. When the 6G system supports the emergency service fallback, the UE may request the emergency service fallback from a network entity of the 6G system in the state of having a connection with the 6G system, and the UE may use an emergency service in the 5G system via the inter-system handover. Alternatively, the UE may request the emergency service fallback from a network entity of the 5G system in the state of having a connection with the 5G system, and may use an emergency service in the 6G system via the inter-system handover. The emergency service may be, for example, a packet-based voice service. For example, via the 5G system, a nationwide network-based voice service (e.g., referred to a voice over NR (VoNR) indicating a voice service in a NR network) may be provided. However, in the case of the 6G system, based on the assumption of a network environment that is difficult to provide a voice service in some regions, when a UE in the state of having a connection with the 6G system is located in the regions where the voice service is difficult to be provided, the UE may receive the voice service in the 5G system via an inter-system handover that uses the emergency service fallback. The disclosure may be applicable to various commercial and/or public services providable to UEs via inter-system handover, in addition to the emergency service fallback.

In the inter-system handover procedure provided in the disclosure, a first network may be one of the networks of the 6G system and the 5G system, and a second network may be another one of the networks of the 6G system and the 5G system. In an handover procedure from the first network to the second network, a UE may perform a random access procedure to a target cell of the second network. The target cell may be a cell selected from at least one candidate cell belonging to the second network, in order to minimize the effect from a delay caused by the inter-system handover procedure. The target cell selection may be performed, for example, by a first network entity that manages mobility of the UE in the first network that the UE accesses. The first network entity may be, for example, an AMF in the case of the 5G system, and may be an AMF or a network entity that performs an operation corresponding to the AMF in the case of the 6G system. The first network entity may obtain neighboring cell information of the UE for the target cell selection, and may identify/determine at least one candidate cell.

In addition, in the disclosure, the first network entity may check/identify/calculate a delay for each of the at least one candidate cell periodically or aperiodically or when an event occurs. In addition, based on delay information checked/identified/calculated for a selected target cell, the first network entity may determine/select whether the UE is to perform a 2-step random access procedure (hereinafter, 2-step random access channel (RACH) procedure) or a 4-step random access procedure (hereinafter, 4-step RACH procedure), as a random access procedure for obtaining an uplink synchronization in the target cell of the second network. In this instance, based on the delay information of the selected target cell, the first network entity may determine a procedure which a degree of the delay is appropriate for between the 2-step RACH procedure and 4step RACH procedure, and may determine/select the corresponding RACH procedure. The first network entity may provide information associated with the determined/selected RACH procedure to a second network entity that manages mobility of the UE in the second network, in the inter-system handover procedure. The second network entity may be, for example, an AMF in the case of the 5G system, and may be an AMF or a network entity that performs an operation corresponding to the AMF in the case of the 6G system. The first network entity may provide information indicating the selected RACH procedure (e.g., information indicating the 2-step RACH or 4-step RACH procedure) (hereinafter, referred to as “RACH type information”) to the second network entity. The first network entity may receive configuration information associated with the determined/selected RACH procedure from the second network entity, and may provide, to the UE, the configuration information together with a handover command. As another example, when the 2-step RACH procedure is selected, the first network entity may provide RACH type information indicating the 2-step RACH procedure to the second network entity, and when the 4-step RACH procedure is selected, the first network entity may not transmit RACH type information indicating the 4-step RACH procedure to the second network entity but may transmit a handover command to the UE, so that a general 4-step RACH procedure is performed.

The configuration information provided from the second network entity to the first network entity may include at least one from among RACH configuration information associated with the selected RACH procedure, master information block (MIB) information, and system information block (SIB) information of the selected target cell. In the disclosure, the configuration information may be referred to as inter-system handover related configuration information. The inter-system handover related configuration information may be provided to the UE, together with a handover command. The UE may receive the MIB, SIB, and/or RACH configuration information associated with the target cell from the first network entity in advance, and thus the UE may omit a cell search operation for searching for the target cell and may reduce a time spent in a random access procedure. Therefore, according to the disclosure, a delay in the inter-system handover procedure may be dramatically reduced.

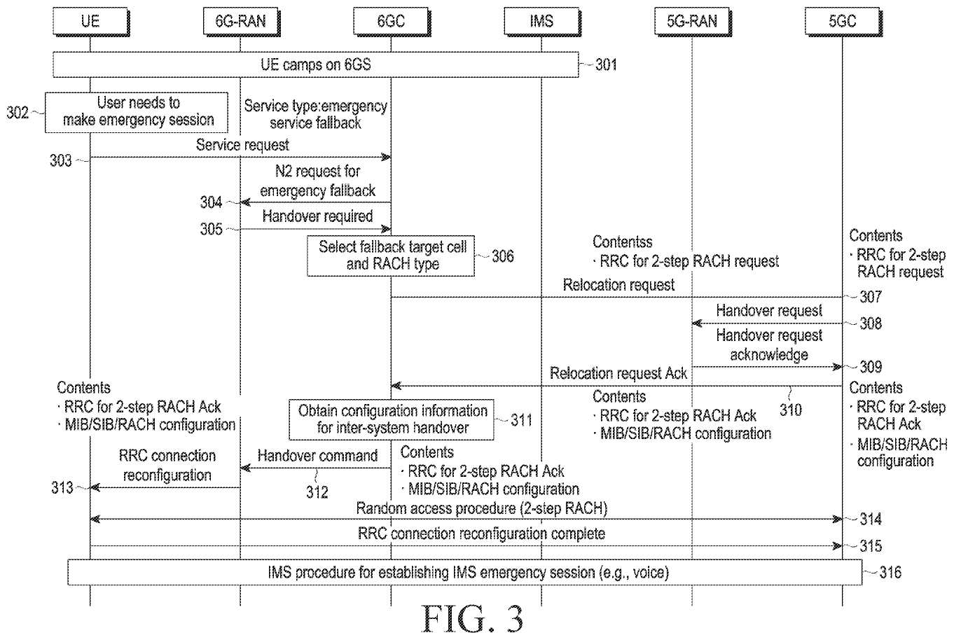

FIG. 3 is a diagram illustrating an example of an inter-system handover procedure in a wireless communication system that supports an emergency service fallback according to an embodiment of the disclosure. In the example of FIG. 3, although a description is provided using an emergency service fallback in an inter-system handover procedure as an example for ease of description, the inter-system handover procedure of the disclosure is not limited to the emergency service fallback. If a service coverage is limited in one system when the system provides various commercial services or public services, or the like such as a voice service, a video service, or the like, the inter-system handover procedure of the disclosure may be applied so as to provide a fallback service to a UE in another system that the one system is capable of interworking with.

In the example of FIG. 3, a network entity that performs signaling in each of a 6GC and a 5GC may be a network entity (e.g., an AMF or an entity corresponding to the AMF) that manages the mobility of a UE. In the 6GC and 5GC, another network entity, besides the AMF, may perform the same operation.

Referring to FIG. 3, it is assumed that the UE is in the state of camping on a source cell in the 6G system in operation 301, and has the specific service from a higher layer, for example, an internet protocol (IP) multimedia subsystem (IMS) emergency session request (e.g., voice service or video service, or the like) that is an emergency service. In operation 303, in the 6G system, the first network entity (e.g., an AMF or an entity corresponding to the AMF) may receive, from the UE, a service request message including a service type and indicating that an emergency service fallback is needed. In operation 304, the first network entity executes a procedure indicating, to the 6G RAN, that the service request in operation 303 is a fallback for an emergency service, and triggers a request for the emergency service fallback. In operation 305, the first network entity may receive, from the 6G RAN, a handover request message that triggers, for example, an inter-system handover from the 6G system to the 5G system, for the emergency service fallback. In operation 306, the first network entity may perform target cell selection for the emergency service fallback, and may perform RACH type selection that selects one of a 2-type RACH procedure and a 4-step RACH procedure based on delay information of a target cell, as described above. The example of FIG. 3 is provided on the assumption that the 2-step RACH procedure is selected. In operation 306, the target cell selection is performed in a manner of selecting the target cell from at least one candidate cell belonging to at least one 5G RAN (base station) based on mapping information based on geographical locations of at least one 6G RAN (base station) including the base station that the UE accesses and at least one 5G RAN (base station) adjacent to the at least one 6G RAN in the inter-system handover of the UB. The mapping information may be stored in the first network entity in advance, or may be provided from another network entity in the 6GC.

FIGS. 4A and 4B are diagrams illustrating examples of a target cell selection operation according to an embodiment of the disclosure. In the disclosure, a plurality of 6G RANs (i.e., 6G base stations) may be disposed in a cell coverage of a 5G RAN (i.e., 5G base station), and at least one 6G base station may be co-located with the 5G base station. The term “co-located” indicates that at least one 6G base station may be disposed in geographically almost the same location as the location of the 5G base station.

FIG. 4A illustrates the case in which a 6G base station that is “co-located” with a 5G base station exists among 6G base stations(s) that a UE 401 accesses. It illustrates the case in which a plurality of 6G base stations (e.g., transmission reception points (TRPs)) (#1-0, #1-1, #1-2, #1-3) are disposed in a cell coverage 41 of a 5G base station #1-0 and a 6G base station #1 and a 5G base station #1-0 are “co-located” and a plurality of 6G base stations (e.g., TRPs) (#2-0, #2-1, #2-2, #2-3) are disposed in a cell coverage 42 of a 5G base station #2 and a 6G base station #2-0 and a 5G base station #2 are “co-located.” In the example of FIG. 4A, when it is assumed that the UE 401 is in the state of having a connection with the 6G base stations #1-2, #2-0, and #2-3, a cell of the 5G base station #2 that is “co-located” with the 6G base station #2-0 may be selected as a target cell for inter-system handover. In the disclosure, the “co-located” base stations may be identified based on the mapping information.

FIG. 4B illustrates the case in which a 6G base station that is “co-located” with a 5G base station does not exist among 6G base stations(s) that the UE 401 accesses. It illustrates the case in which the plurality of 6G base stations (e.g., TRPs) (#1-0, #1-1, #1-2, #1-3) are disposed in the cell coverage 41 of the 5G base station #1-0 and the 6G base station #1 and the 5G base station #1-0 are “co-located” and the plurality of 6G base stations (e.g., TRPs) (#2-0, #2-1, #2-2, #2-3) are disposed in the cell coverage 42 of the 5G base station #2 and the 6G base station #2-0 and the 5G base station #2 are “co-located.” In the example of FIG. 4B, when it is assumed that the UE 401 is in the state of having a connection with the 6G base stations #1-1, #1-2, and #2-3, it is identified that no 5G base station is “co-located” with the 6G base station #1-1, #1-2, and #2-3. In this instance, a cell of the 5G base station #1 of which the coverage at least partially overlaps the 6G base station #1-1 of a source cell or which is geographically relatively close to the 6G base station #1-1 may be selected as a target cell for inter-system handover. In the disclosure, a 5G base station of which the coverage at least partially overlaps a 6G base station or which is geographically relatively close to the 6G base station may be identified based on the mapping information.

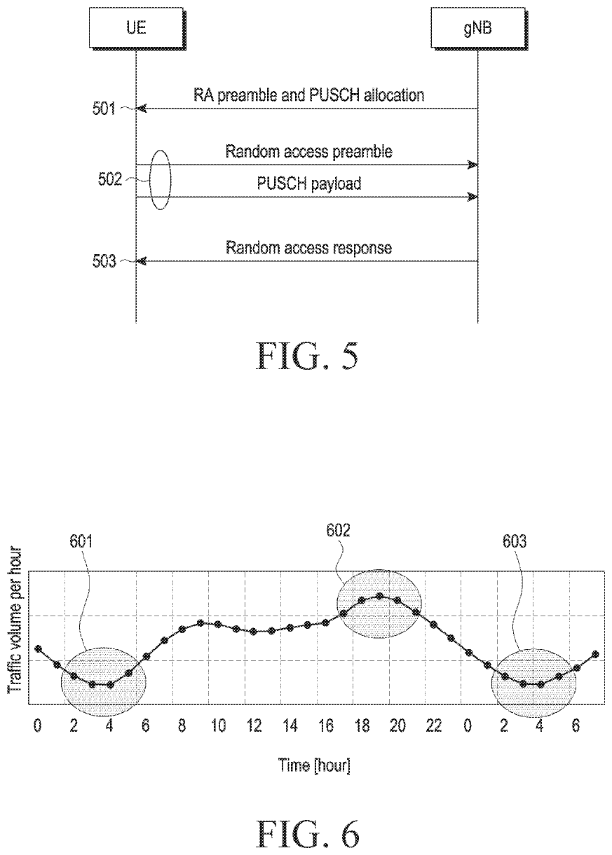

FIG. 5 is a diagram illustrating a general 2-step RACH procedure. The 2-step RACH procedure and 4-step RACH procedure may use procedures defined in TS38.300.

According to operations 501 to 503 of FIG. 5, a contention-free (contention-free random access (CFRA))-based 2-step RACH procedure may be performed. A base station may allocate a preamble for random access and a PUSCH resource to a UE in operation 501, and the UE may transmit PUSCH data together with a preamble to the base station in operation 502. In operation 503, the base station transmits a random access response message to the UE. Operation 502 in the 2-step RACH procedure performs the two-step operation that performs preamble transmission and scheduled transmission using Msg3 in the 4-step RACH procedure, as a single operation, and operation 503 performs responding to the preamble transmission and responding to the Msg3 transmission, as a single operation. Therefore, the 2-step RACH procedure may reduce a delay time when compared to the 4-step RACH procedure.

Referring again to the description of FIG. 3, in operation 306, the first network entity selects a target cell using mapping information stored in advance as described above, and may perform RACH type selection that selects one of the 2-step RACH procedure and the 4-step RACH procedure based on delay information of the target cell. For example, generally, on the assumption that a time needed for the 2-step RACH procedure is 100 ms and a time needed for the 4-step RACH procedure is 200 ms, when delay information (delay value) of the selected target cell is less than 100 ms, and the UE performs the 2-step RACH procedure with respect to the target cell, a time of 100 ms+delay value (i.e., a time less than 200 ms) may be consumed. In this instance, selecting the 2-step RACH procedure, rather than the 4-step RACH procedure, may be more effective for reducing a delay in the inter-system handover procedure. On the assumption that the delay information (delay value) of the selected target cell is greater than 100 ms in the same condition, when the UE performs the 2-step RACH procedure with respect to the target cell, a time of 100 ms+delay value (i.e., a time greater than 200 ms) may be consumed. In this instance, selecting the 2-step RACH procedure is not effective for reducing a delay in the inter-system handover procedure, and thus the 4-step RACH procedure may be selected.

For the RACH type selection, the first network entity may use the delay information of the target cell. In the disclosure, the delay information may indicate a delay time occurring in a signaling process between a 6GC and a 5GC. The inter-system handover procedure provided in the disclosure requires signaling between the 6GC and the 5GC, and may use the delay information for selecting an appropriate RACH type which may reduce a delay time in the inter-system handover procedure.

The delay information in the disclosure may be checked/identified/calculated with respect to at least one of a plurality of 5G base stations of the 5G system, periodically or aperiodically or when a predetermined event, such as a change of a virtualized environment of a base station or the like, occurs. For example, the virtualized environment change of the base station may be technology that embodies, based on software, a network function provided by the base station, for example, virtualized radio access network (vRAN) technology. The vRAN technology embodies a centralized unit (CU) and a distributed unit (DU) among the functions of the base station in a server connected to a network, and may increase or decrease the number of CUs and DUs by area or time via scaling in/out. FIG. 6 is a diagram is to describe scalability technology in base station virtualization, and illustrates an example of increasing or decreasing the number of DUs in consideration of the amount of traffic by time. For example, in a time interval where the amount of traffic is relatively low as shown in reference numerals 601 and 603 of FIG. 6, the number of virtualized DUs in the corresponding area may be reduced. When the amount of traffic is relatively high as shown in reference numeral 602, the number of virtualized DUs in the corresponding area may be increased. As described above, in a virtualized environment of network entities, a delay time of an AMF, UPF, SMF, CU, DU, or the like may be changed. By using vRAN scalability technology, a delay time may be changed by scaling in/out DU pods or migration (ex. fail over.).

For example, by using vRAN scalability technology in a vRAN virtualized environment where cell #1, 2, and 3 corresponding to TRPs are connected to DU #1 and CU #1, the virtualized environment may be changed to a vRAN virtualized environment where cell #1 and 2 are connected to DU #1 and CU #1, and cell #3 is connected to DU #2 and CU #2. In this instance, when cell #3 is a target cell, a delay time of cell #3 may be changed based on a change of the vRAN virtualized environment.

Therefore, in order to accurately identify the change of the delay time of the target cell based on the change of the virtualized environment of the base station, it is required to identify the change of the delay time of the target cell periodically, aperiodically, or when a predetermined event, such as a virtualized environment change or the like, occurs, before the target cell is selected. The use of the virtualized base station is an example in which a delay time of a target cell may be changed, and the disclosure is not limited to the case that uses a virtualized base station. For example, the disclosure may be applied equally, even in a communication environment where the disposition of base stations is physically stationary. The identification of the delay time is performed not only with respect to a target cell for inter-system handover, but also is performed with respect to a plurality of candidate cells of the 5G system in the example of FIG. 3, before the target cell selection.

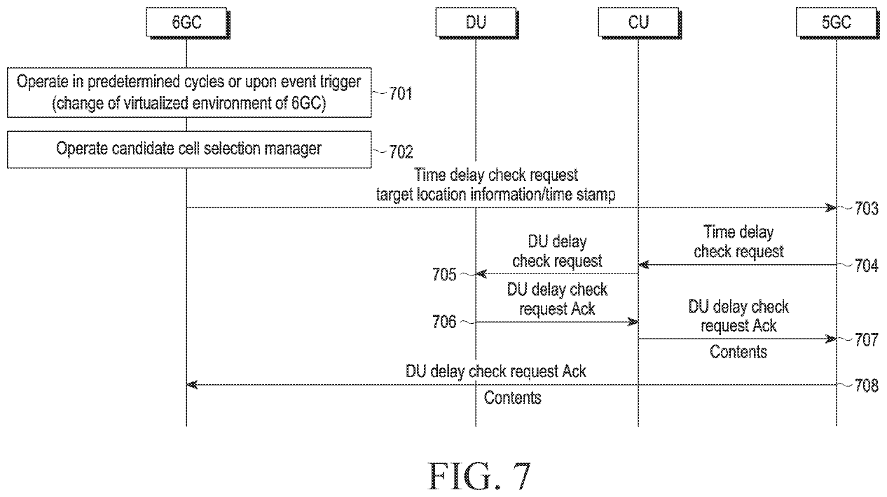

FIG. 7 is a diagram illustrating a delay time identification procedure applied to an inter-system handover procedure according to an embodiment of the disclosure, and FIG. 7 is a diagram illustrating a procedure (hereinafter, a delay time identification procedure) that identifies a delay time for each of a plurality of candidate cells before selecting a target cell in the inter-system handover.

In operation 701 of FIG. 7, the delay time identification procedure in the disclosure may be performed periodically, aperiodically, or when a predetermined event, such as a change of a virtualized environment of a base station, occurs. Therefore, the delay time identification procedure of FIG. 7 may be performed in parallel with the procedure of FIG. 3, or may be performed at any point in time while operations 301 to 316 of FIG. 3 are performed. In the disclosure, a first network entity that manages mobility in a 6GC may include a candidate cell selection manager. The candidate cell selection manager may perform the delay time identification procedure of FIG. 7, as well as the above-described target cell selection operation. In operation 702, according to an operation routine of the candidate cell selection manager, the first network entity may transmit, to a second network entity that manages mobility in a 5GC, a first request message for checking a delay time and including location information of candidate cells of the 5G system and a time stamp, in order to identify a delay time, in operation 703. The candidate cell selection manager is used for ease of description, and the operation of the candidate cell selection manager may be controlled by a processor (instance) of the first network entity.

The location information may be determined based on the location information of a 6G base station that a UE accesses. For example, when the UE accesses a 6G base station located in Gangnam-gu in Seoul, the location information may be Gangnam-gu location information. A geographical range of the location information may be variably configured based on a communication environment. In the case of location information indicating a broad area, the number of candidate cells for delay time identification may be large. In the case of location information indicating a small area, the number of candidate cells for delay time identification may be relatively small.

In the case of the time stamp, when a plurality of candidate cells for delay time identification exist, the DUs (or TRPs) corresponding to the candidate cells may be distributed at various geographical locations, with reference to a CU. Since a distance between a DU (or TRP) corresponding to each candidate cell and the CU is different, and thus a degree of a delay in signaling between the DU and CU may be different for each candidate cell. Therefore, in the disclosure, a signaling section to CUs, the number of which is smaller than the number of DUs, that is, a signaling section including a path between the first network entity and the second network entity and a path between the second network entity and at least one CU, a first delay time is calculated/measured based on the time stamp. In a signaling section between a CU and each of a plurality of DU connected thereto, a second delay time may be calculated/measured. In other words, a delay occurring in the path between the first network entity of the 6G system and a CU of the 5G system may be identified as the first delay time, and a delay occurring in the path between the CU of the 5G system and each DU may be identified as the second delay time. Each of the first delay time and the second delay time may be calculated/measured in a corresponding CU of the 5G system.

In operation 704, the second network entity that receives the location information and the time stamp may transmit a second request message including the time stamp and for checking the first delay time, to at least one CU belonging to the location information. In operation 705, the at least one CU that receives the second request message may transmit a third request message for checking the second delay time to a plurality of DUs (i.e., candidate cells) connected to the corresponding CU. Although one CU and one DU are illustrated in FIG. 7 for ease of description, a plurality of CUs and a plurality of DUs may exist. Subsequently, in operation 706, each CU may receive a first response message from each of the plurality of DUs (i.e., candidate cells) connected thereto, may calculate/measure the first delay time based on the time stamp, and may calculate/measure a second delay time for each DU based on a time spent in receiving the first response message from each of the plurality of DUs.

In operation 707, the second network entity may receive, from each CU that receives the second request message, a second response message including delay information associated with the plurality of candidate cells (DUs) including the first delay time for each CU and the second delay time for each DU. In operation 708, the first network entity may receive a third response message including the delay information associated with the plurality of candidate cells (DUs) from the second network entity. Based on the delay information associated with the plurality of candidate cells (DUs) including a target cell, the first network entity may identify delay information of the target cell.

Referring again to the description with reference to FIG. 3, the first network entity that selects the target cell for an emergency service fallback, identifies delay information of the target cell via the delay time identification procedure of FIG. 7, and selects the RACH type that the UE is to perform with respect to the target cell in operation 306, transmits a relocation request message including the target cell information (e.g., identification information) and the RACH type information selected for the target cell to the second network entity of the 5G system in operation 307. The second network entity that identifies the target cell information and selected RACH type transmits a handover request message including information indicating the selected RACH type to the corresponding 5G base station that the target cell belongs to, in operation 308 and receives a response message to the handover request in operation 309. In the embodiment of the disclosure, it is assumed that a handover request is accepted. In operation 309, the response message may include configuration information of the target cell (e.g., inter-system handover related configuration information). The configuration information may include at least one of RACH configuration information, MIB, and SIB information of the target cell. The RACH configuration information may be included in the response message when the selected RACH type is the 2-step RACH procedure, and may not be included in the response message when the selected RACH type is the 4-step RACH procedure. As an optional embodiment, the RACH configuration information may be included in the response message although the selected RACH type is the 4-step RACH. As the RACH configuration information, for example, RACH configuration information illustrated in 3GPP TS 38.331 may be used.

Subsequently, in operations 310 and 311, the first network entity may receive a response message including the inter-system handover related configuration information from the second network entity of the 5G system in response to the transmission of the relocation request message of operation 307, and may obtain the inter-system handover related configuration information. In operation 312, the first network entity may transmit, to the 6G RAN that the UE accesses, the inter-system handover related configuration information together with a handover command. The UE may receive an RRC connection reconfiguration message including the inter-system handover related configuration information from the 6G RAN in operation 313, and may perform a random access procedure with respect to the target cell based on the inter-system handover related configuration information in operations 314 and 315. The example of FIG. 3 is provided on the assumption that the 2-step RACH procedure is performed. Subsequently, in operation 316, the UE performs a procedure for establishing an IMS emergency session and may receive an emergency service requested in operation 303

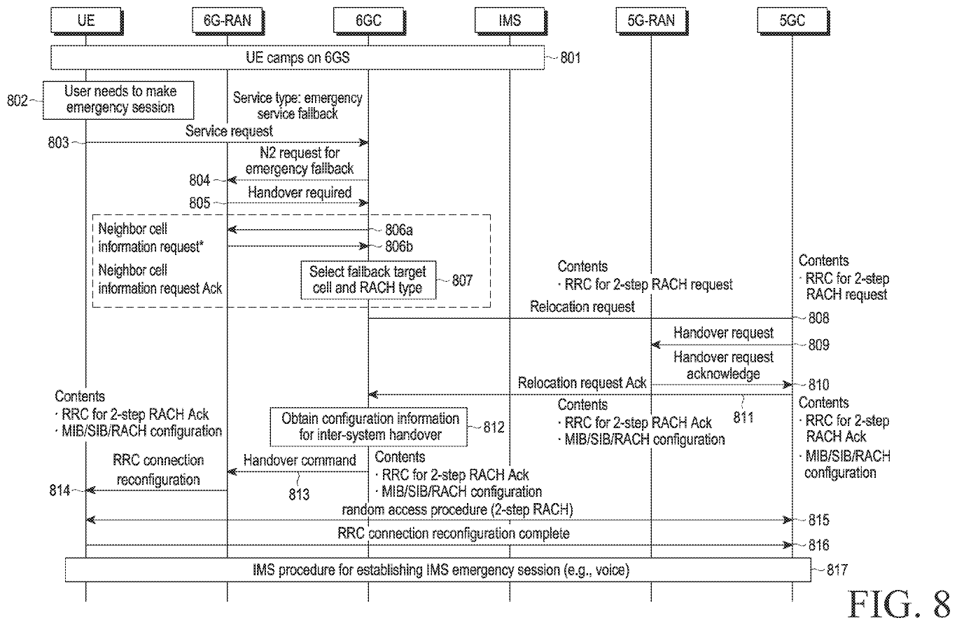

FIG. 8 is a diagram illustrating an example of an inter-system handover procedure in a wireless communication system that supports an emergency service fallback according to an embodiment of the disclosure. In the embodiment of FIG. 8, operations 801 to 805 and operations 808 to 817 are the same as the corresponding operations that have been described in the embodiment of FIG. 3 and thus, a detailed description of the same operations will be omitted.

When compared to the embodiment of FIG. 3, the embodiment of FIG. 8 describes another scheme of selecting a target cell by a first network entity. In the embodiment of FIG. 3, the first network entity may store mapping information in advance or may obtain the mapping information from another network entity in advance, wherein the mapping information is based on geographical locations of at least one 6G RAN (base station) including a base station that a UE accesses and at least one 5G RAN (base station) that is adjacent to the at least one 6G RAN, and may select, based on the mapping information, the target cell from among at least one candidate cell belonging to the at least one 5G RAN (base station). In the embodiment of FIG. 8, in operation 806a, the first network entity requests provision of neighboring cell list information of each 6G RAN from the 6G RAN(s). The neighboring cell list information may include list information of a 5G RAN(s) adjacent to the corresponding 6G RAN. The adjacent 5G RAN(s) may be candidate cells when a target cell for inter-system handover is selected. The first network entity may receive the neighboring cell list information from each 6G RAN that receives the request of operation 806a, in operation 806b, and may select, as the target cell, a cell of a 5G RAN that is most redundantly listed among the 5G RANs collected based on the neighboring cell list information.

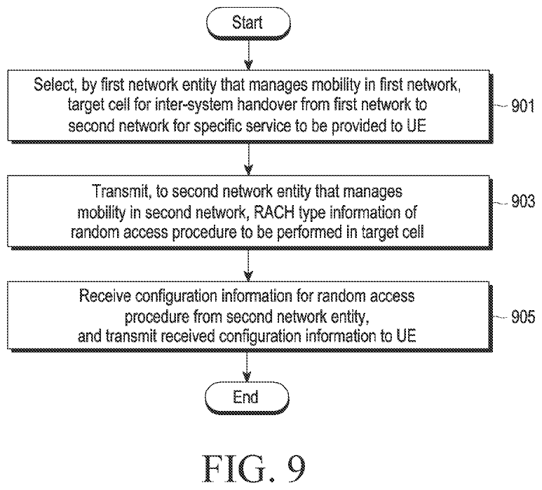

FIG. 9 is a diagram illustrating an operation performed in a first network entity of a 6G system in an inter-system handover procedure according to an embodiment of the disclosure.

In operation 901 of FIG. 9, a first network entity that manages mobility in a first network (e.g., 6G system) may select a target cell for an inter-system handover from the first network to a second network (e.g., 5G system), for a specific service that a UE requests (or that is to be provided to a UE). The target cell selection operation may be performed using the scheme described with reference to FIG. 3 or FIG. 8. In operation 903, the first network entity may transmit RACH type information associated with a random access procedure to be performed in the selected target cell, to a second network entity that manages mobility in the second network. In operation 903, based on delay information obtained using the delay time identification procedure that has been described with reference to the embodiment of FIG. 7, the RACH type selection may be performed to select, from a 2-step RACH procedure and a 4-step RACH procedure, an appropriate RACH type that reduces a delay time in the inter-system handover procedure. Subsequently, in operation 905, the first network entity receives configuration information for a random access procedure from the second network entity, and transmits the received configuration information to the UE. The configuration information may be, for example, the above-described inter-system handover related configuration information, and may be provided to the UE together with a handover command. The UE may receive MIB, SIB, and/or RACH configuration information associated with the target cell from the first network entity in advance, and thus the UE may omit a cell search operation for searching for the target cell and may reduce a time spent in the random access procedure.

The embodiments of the disclosure illustrate an inter-system handover procedure from the 6G system to the 5G system, for a specific service of a UE. The embodiments of the disclosure may be performed in the same or similar manner in an inter-system handover procedure from the 5G system to the 6G system.

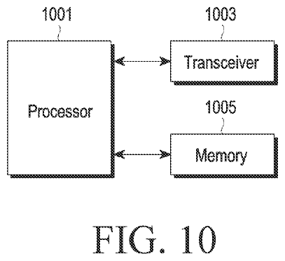

FIG. 10 is a diagram illustrating an example of a configuration of a network entity in a wireless communication system according to an embodiment of the disclosure. The network entity of FIG. 10 may be one of a UE, an RAN (base station), a first network entity, and a second network entity, described in the embodiments of FIG. 1 to FIG. 9.

The network entity according to an embodiment of the disclosure may include a processor 1001 to control the overall operation of the network entity, a transceiver 1003 including a transmitter and a receiver, and memory 1005. The network entity is not limited to the example, and may include fewer or more components than the components of FIG. 10.

According to an embodiment of the disclosure, the transceiver 1003 may perform signal transmission or reception with other network entities or a UE. The transmitted or received signal may include at least one of control information and data. When the network entity of FIG. 10 is an entity of a core network, a signal transmitted or received between the network entity and a UE may transmitted or received via an RAN.

According to an embodiment of the disclosure, the processor 1001 may control the overall operation of the corresponding network entity so as to perform operations based on one of the above-described embodiments of FIG. 1 to FIG. 9 or a combination of two or more embodiments thereof. The processor 1001, the transceiver 1003, and the memory 1005 may not be necessarily embodied as separate modules, and may also be embodied as a single configuration such as a single chip. In addition, the processor 1001 may be an application processor (AP), a communication processor (CP), a circuit, an application-specific circuit, or at least one processor. The transceiver 1003 may include at least one communication interface that performs signal transmission or reception with another network entity in a wired/wireless manner.

According to an embodiment, the memory 1005 may store data such as a basic program, an application program, configuration information, and the like for operating the corresponding network entity. In addition, the memory 1005 may provide data stored therein by request of the processor 1001. The memory 1005 may be embodied as a storage medium such as a ROM, a RAM, a hard disk, a CD-ROM, a DVD, and the like, or a combination of storage media. In addition, a plurality of pieces of memory 1005 may be present. In addition, the processor 1001 may perform at least one of the above-described embodiments based on a program stored in the memory 1005 and for implementing an operation according to at least one of the embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. Therefore, the scope of various embodiments of the disclosure should be construed to include, in addition to the embodiments set forth herein, all changes and modifications derived based on the technical idea of various embodiments of the disclosure. Also, the above respective embodiments may be employed in combination, as necessary.

1. A method performed by a first network entity that manages mobility in a first system in an inter-system handover procedure, the method comprising:
selecting a target cell from among at least one candidate cell for an inter-system handover from a first system to a second system, for a specific service for a user equipment (UE);
transmitting, to a second network entity that manages mobility in the second system, a first request message including type information for a random access procedure to be performed by the target cell;
receiving a first response message including inter-system handover related configuration information from the second network entity in response to the transmission of the first request message; and
transmitting, to a base station of the first system that the UE accesses, the inter-system handover related configuration information together with a handover command.

2. The method of claim 1, wherein the selecting of the target cell further comprises:
based on mapping information based on geographical locations between at least one first base station of the first system and at least one second base station adjacent to the at least one first base station in the second system, selecting the target cell among at least one candidate cell that belongs to the at least one second base station.

3. The method of claim 1, wherein the selecting of the target cell comprises:
requesting, by the first network entity, neighboring cell list information corresponding to candidate cells in the second system to at least one base station including the base station that the UE accesses in the first system;
receiving the neighboring cell list information from the at least one base station in response to the request; and
based on the neighboring cell list information, selecting the target cell from among the candidate cells.

4. The method of claim 1, further comprising:
performing a delay time identification procedure that checks a delay time related to at least one candidate cell including the target cell in the inter-system handover procedure; and
based on delay information of the target cell identified in the delay time identification procedure, selecting a random access procedure to be performed in the target cell,
wherein the type information indicates one of a 2-step random access procedure and a 4-step random access procedure.

5. The method of claim 4, wherein the delay time identification procedure is performed periodically or performed in case that a predetermined event occurs due to a change of a virtualized environment of a base station.

6. The method of claim 4, wherein the delay time related to the at least one candidate cell comprises a first delay time and a second delay time,
wherein the first delay time is measured in a signaling section including a path between the first network entity and the second network entity and a path between the second network entity and a centralized unit (CU) connected to at least one distributed unit (DU) corresponding to the at least one candidate cell, and
wherein the second delay time is measured in a signaling section between the at least one DU connected to the CU.

7. The method of claim 4, wherein the performing of the delay time identification procedure further comprises:
transmitting, by the first network entity to the second network entity, a second request message including location information of the base station that the UE accesses and a time stamp and for checking a delay time; and
receiving, by the first network entity, delay information indicating a delay time related to the at least one candidate cell in response to the second request message.

8. The method of claim 1, wherein the specific service comprises a service related to an emergency service fallback, and
wherein, in case that the first network entity receives a service request message including a service type of the specific service from the UE, the inter-system handover procedure is initiated.

9. A first network entity that manages mobility in a first system, the first network entity comprising:
a communication interface; and
a processor, in an inter-system handover procedure, configured to
select a target cell from among at least one candidate cell in order to perform an inter-system handover from the first system to a second system, for a specific service for a user equipment (UE),
transmit, via the communication interface, a first request message including type information for a random access procedure to be performed in the target cell to a second network entity that manages mobility in the second system,
receive a first response message including inter-system handover related configuration information from the second network entity via the communication interface in response to the transmission of the first request message, and
transmit, to a base station of the first system that the UE accesses, the inter-system handover related configuration information together with a handover command via the communication interface.

10. (canceled)

11. A method performed by a user equipment (UE) in an inter-system handover procedure, the method comprising:
transmitting a service request message including a service type of a specific service to a first network entity that manages mobility of the UE in a first system;
receiving inter-system handover related configuration information from the first network entity in response to the transmission of the service request message; and
based on the inter-system handover related configuration information, performing a random access procedure with a target cell in a second system for inter-system handover.

12. The method of claim 11, wherein the inter-system handover related configuration information comprises at least one of a master information block (MIB) of the target cell, a system information block (SIB), and random access channel (RACH) configuration information used in performing the random access procedure with the target cell by the UE.

13. A user equipment (UE) in a wireless communication system, the UE comprising:
a transceiver; and
a processor configured to
transmit, via the transceiver, a service request message including a service type of a specific service to a first network entity that manages mobility of the UE in a first system,
receive, via the transceiver, inter-system handover related configuration information from the first network entity in response to the transmission of the service request message, and
perform, via the transceiver, a random access procedure with a target cell in a second system for inter-system handover, based on the inter-system handover related configuration information.

14. The UE of claim 13, wherein the inter-system handover related configuration information comprises at least one of a master information block (MIB) of the target cell, a system information block (SIB), and random access channel (RACH) configuration information used in performing the random access procedure with the target cell by the UE.

15. The first network entity of claim 9, wherein the processor is further configured to:
select the target cell among at least one candidate cell that belongs to the at least one second base station, based on mapping information based on geographical locations between at least one first base station of the first system and at least one second base station adjacent to the at least one first base station in the second system.

16. The first network entity of claim 9, wherein the processor is configured to:
request, by the first network entity, neighboring cell list information corresponding to candidate cells in the second system to at least one base station including the base station that the UE accesses in the first system;
receive, via the communication interface, the neighboring cell list information from the at least one base station in response to the request; and
select the target cell from among the candidate cells, based on the neighboring cell list information.

17. The first network entity of claim 9, wherein the processor is further configured to:
perform a delay time identification procedure that checks a delay time related to at least one candidate cell including the target cell in the inter-system handover procedure; and
select a random access procedure to be performed in the target cell, based on delay information of the target cell identified in the delay time identification procedure,
wherein the type information indicates one of a 2-step random access procedure and a 4-step random access procedure.

18. The first network entity of claim 18, wherein the delay time identification procedure is performed periodically or performed in case that a predetermined event occurs due to a change of a virtualized environment of a base station.

19. The first network entity of claim 18, wherein the delay time related to the at least one candidate cell comprises a first delay time and a second delay time,
wherein the first delay time is measured in a signaling section including a path between the first network entity and the second network entity and a path between the second network entity and a centralized unit (CU) connected to at least one distributed unit (DU) corresponding to the at least one candidate cell, and
wherein the second delay time is measured in a signaling section between the at least one DU connected to the CU.

20. The first network entity of claim 18, wherein the processor is further configured to:
transmit, to the second network entity via the communication interface, a second request message including location information of the base station that the UE accesses and a time stamp and for checking a delay time, and
receive, via the communication interface, delay information indicating a delay time related to the at least one candidate cell in response to the second request message.

21. The first network entity of claim 9, wherein the specific service comprises a service related to an emergency service fallback, and
wherein, in case that the first network entity receives a service request message including a service type of the specific service from the UE, the inter-system handover procedure is initiated.
